(19) United States
(12) Patent Application Publication
(10) Pub. No.: US 2023/0239154 A1
(43) Pub. Date: Jul. 27, 2023

(54) SECURE COMMUNICATION OF USER DEVICE DATA

(71) Applicant: BRITISH TELECOMMUNICATIONS PUBLIC LIMITED COMPANY, London (GB)

(72) Inventors: Aftab ALI, London (GB); Gery DUCATEL, London (GB); Zhan CUI, London (GB); Mamun ABU-TAIR, London (GB); Joseph RAFFERTY, London (GB); Hanif ULLAH, London (GB); Philip MORROW, London (GB)

(21) Appl. No.: 18/002,704

(22) PCT Filed: Jun. 15, 2021
(86) PCT No.: PCT/EP2021/066113

§ 371 Date: Dec. 21, 2022

(30) Foreign Application Priority Data
Jun. 25, 2020 (GB) 2009728.3

(51) Int. Cl. H04L 9/32; H04L 9/08

(52) U.S. Cl. CPC H04L 9/3231; H04L 9/0866

(57) ABSTRACT

A method for facilitating secure communication between a user device and a network device. Encrypted data from a user device is received at the network device. The encrypted data is encrypted based on first physiological data captured by a first sensor of the user device. The first physiological data is representative of a physiological characteristic of a user of the user device. A second sensor of the network device captures second physiological data representative of the physiological characteristic of the user. A common key for encrypting further data transferred between the user device and the network device is determined, based on the encrypted data and the second physiological data. Further aspects relate to other methods for facilitating secure communication between a user and network device, a network, and a method of operating a network.

### PRIORITY CLAIM

The present application is a National Phase entry of PCT Application No. PCT/EP2021/066113, filed Jun. 15, 2021, which claims priority from GB Patent Application No. 2009728.3, filed Jun. 25, 2020, each of which is hereby fully incorporated herein by reference.

### TECHNICAL FIELD

The present disclosure relates to facilitating secure communication between a user device and a network device. The present disclosure further relates to facilitating secure communication of data captured by a user device to a client device.

### BACKGROUND

An increasing number of devices are being provided with the means to communicate data. The Internet of Things (IoT) is a network of user devices such as home appliances, vehicles and other items embedded with electronics, software, sensors, actuators, and/or connectivity which enable these devices to connect with each other and/or other computer systems and exchange data.

User devices are increasingly being deployed in scenarios such as healthcare, assisted living facilities and smart home environments. Data collected in these scenarios can include sensitive personal data. Securing user devices and the data obtained by user devices in these scenarios is therefore vital.

Current security solutions use pre-deployed credentials to provide for secure communication between user devices. However, a malicious third party may be able to access the pre-deployed credentials if they steal a user device containing such credentials. The third party may then be able to gain unauthorized access to the user device and other user devices within a given IoT, and to personal data collected by the user device(s).

### SUMMARY

It is desirable to at least alleviate some of the aforementioned problems.

According to a first aspect of the present disclosure, there is provided a method for facilitating secure communication between a user device and a network device, the method comprising: receiving, at the network device, encrypted data from the user device, wherein the encrypted data is encrypted based on first physiological data captured by a first sensor of the user device, the first physiological data representative of a physiological characteristic of a user of the user device; a second sensor of the network device capturing second physiological data representative of the physiological characteristic of the user; and determining, based on the encrypted data and the second physiological data, a common key for encrypting further data transferred between the user device and the network device.

In some examples, the encrypted data is encrypted using a first key with a value dependent on the first physiological data, and determining the common key comprises: the network device generating a second key with a value dependent on the second physiological data; and the network device using the second key to decrypt the encrypted data, thereby determining that the first key and the second key each correspond to the common key.

In some examples, the first physiological data is captured synchronously with the capturing of the second physiological data.

In some examples, the physiological characteristic is a time-varying physiological characteristic. The first physiological data and the second physiological data may each represent an electrocardiogram (ECG) of the user.

In some examples, the network device comprises a gateway device.

In some examples, the method is performed repeatedly to determine, for each performance of the method, a different respective common key for encrypting data transferred between the user device and the network device during a different respective time period.

In some examples, the method comprises the network device receiving user data from the user device, wherein the user data is encrypted using the common key; and the network device sending further user data derived from the user data to a node of a distributed ledger network (DLN) configured to store a distributed ledger of the DLN, for storage of the further user data in the distributed ledger. In some of these examples, the method comprises: the network device decrypting, using the common key, the user data to generate decrypted user data; and the network device encrypting the decrypted user data using a further key, different from the common key, to generate the further user data. The network device may receive client authorization data from a client device for use in authorizing the client device, validate the client authorization data against a version of the client authorization data stored in the distributed ledger, and send the further key to the client device. In some of these examples, the network device receives user authorization data from the user device for use in authorizing at least one of: the user device or the user; and the network device validates the user authorization data against a version of the user authorization data stored in the distributed ledger before sending the further user data to the node of the DLN. At least a portion of the user authorization data may be indicative of a certificate associated with the user device. The certificate associated with the user device may indicate that at least one of: a configuration of the user device complies with a technical standard or a configuration of the user device complies with a legal requirement. In some of these examples, the network device is associated with a network, and the network device validates the user authorization data against the version of the authorization data stored in the distributed ledger before granting access to the network to the user device.

According to a second aspect of the present disclosure, there is provided a method for facilitating secure communication between a user device and a network device, the method comprising: capturing, at a first sensor of a user device, first physiological data representative of a physiological characteristic of a user of the user device; encrypting, at the user device, the first physiological data based on the first physiological data, thereby generating encrypted data; sending the first physiological data from the user device to a network device; and determining, based on the encrypted data and second physiological data captured by a second sensor of the network device, a common key for encrypting further data transferred between the user device and the network device.

In some examples according to the second aspect, the encrypted data is encrypted using a first key with a value dependent on the first physiological data, and determining the common key comprises: the user device receiving an encrypted response from the network device, the encrypted response indicative of decryption of the encrypted data by the network device using a second key with a value dependent on the second physiological data; and the user device decrypting the encrypted response using the first key, thereby determining that the first key and the second key each correspond to the common key.

In some examples according to the second aspect, the method comprises: the first sensor of the user device capturing further physiological data representative of the physiological characteristic of the user; the user device encrypting the further physiological data using the common key, thereby generating user data; and the user device sending the user data to the network device. In these examples, the method may comprise, before the user device sends the user data to the network device: the user device receiving network device authorization data from the network device for use in authorizing the network device; and the user device validating the network device authorization data against a version of the network device authorization data stored in a distributed ledger. At least a portion of the network device authorization data may be indicative of a certificate associated with the network device. The certificate associated with the network device may indicate that at least one of: a configuration of the network device complies with a technical standard or a configuration of the network device complies with a legal requirement.

In some examples according to the second aspect, the method comprises the user device sending user characteristic data representative of at least one characteristic of at least one of the user device or the user to a verification system configured to verify the at least one characteristic; and the user device receiving, from the verification system, user authorization data for use in authorizing the at least one of the user device or the user. The verification system may be associated with a regulatory authority. The user device may send the user authorization data to the network device for use in authorizing the at least one of: the user device or the user.

According to a third aspect of the present disclosure, there is provided a network comprising: a network device; and a user device comprising a first sensor configured to capture first physiological data representative of a physiological characteristic of a user of the user device, wherein the user device is configured to: encrypt data captured by the first sensor, based on the first physiological data, to generate encrypted data; and send the encrypted data to the network device, wherein the network device comprises a second sensor configured to capture second physiological data representative of the physiological characteristic of the user, and the user device and the network device are configured to determine, based on the encrypted data and the second physiological data, a common key for encrypting further data transferred between the user device and the network device.

According to a fourth aspect of the present disclosure, there is provided a method of operating a network comprising a user device and a network device, the method comprising: capturing, using a first sensor of the user device, first physiological data representative of a physiological characteristic of a user of the user device; encrypting data captured by the first sensor, based on the first physiological data, to generate encrypted data; sending the encrypted data to the network device; capturing, using a second sensor of the network device, second physiological data representative of the physiological characteristic of the user; and determining, based on the encrypted data and the second physiological data, a common key for encrypting further data transferred between the user device and the network device.

According to a fifth aspect of the present disclosure, there is provided a method for facilitating secure communication of user data captured by a user device to a client device, the method comprising: the client device sending client characteristic data representative of at least one characteristic of the client device to a verification system configured to verify the at least one characteristic; the client device receiving, from the verification system, client authorization data for use in authorizing the client device; the client device sending the client authorization data to a network device; the client device receiving a key from the network device; the client device receiving, from a node of a distributed ledger network (DLN), user data captured by a user device; and the client device decrypting the user data using the key.

In some examples of the fifth aspect, the client device is a first client device and the method comprises: the first client device executing a smart contract with a second client device associated with a user of the user device, the smart contract representing an agreement for sharing of the user data with the first client device, wherein the smart contract is stored in a distributed ledger of the DLN.

In some examples of the fifth aspect, at least a portion of the client authorization data is indicative of a certificate associated with the client device. The certificate associated with the client device may indicate that at least one of: a configuration of the client device complies with a technical standard or a configuration of the client device complies with a legal requirement. Examples herein relate to methods and/or apparatus substantially as herein described and/or as illustrated with reference to the accompanying drawings. Further examples herein relate to a computer program and/or a computer program product for carrying out any of the methods described herein and/or for embodying any of the apparatus features described herein, and a computer-readable medium storing thereon a program for carrying out any of the methods and/or for embodying any of the apparatus features described herein. Features described as being implemented in hardware may alternatively be implemented in software, and vice versa.

Yet further examples relate to a method of transmitting a signal, and a computer product having an operating system that supports a computer program for performing any of the methods described herein and/or for embodying any of the apparatus features described herein. Any apparatus feature may also be provided as a corresponding operation of a method, and vice versa. As used herein, means plus function features may alternatively be expressed in terms of their corresponding structure, for example as a suitably-programmed processor.

Any feature in one aspect of the disclosure may be applied, in any appropriate combination, to other aspects of the disclosure. Any, some and/or all features in one aspect can be applied to any, some and/or all features in any other aspect, in any appropriate combination. Particular combinations of the various features described and defined in any aspects of the disclosure can be implemented and/or supplied and/or used independently.

As used throughout, the word ‘or’ can be interpreted in the exclusive and/or inclusive sense, unless otherwise specified.

### BRIEF DESCRIPTION OF THE DRAWINGS

Examples herein relate to methods and systems for facilitating secure communication between a user device and a network device, to methods and systems for facilitating secure communication of user data captured by a user device, to a network, and to a method of operating a network as described herein and/or substantially as illustrated with reference to the accompanying drawings. Examples are now described with reference to the accompanying diagrammatic drawings, in which:

FIG. 1 is a schematic diagram of an example system for establishing a common key.

FIG. 2 is a schematic diagram of an example system for storing data in a distributed ledger.

FIG. 3 is a schematic diagram of an example system for sending user data to a client device.

FIG. 4 is a schematic diagram of an example system for obtaining data from a distributed ledger.

FIG. 5 is a schematic diagram of an example system for authorizing a user device.

FIG. 6 is schematic diagram of an example system for storing user authorization data for authorizing a user device.

FIG. 7 is schematic diagram of an example system for authorizing a network device.

FIG. 8 is a schematic diagram showing internal components of an example data processing system.

### DETAILED DESCRIPTION

The following description is presented to enable any person skilled in the art to make and use the system, and is provided in the context of a particular application. Various modifications to the disclosed embodiments will be readily apparent to those skilled in the art.

Methods and systems in accordance with the present disclosure facilitate secure communication between a user device, such as an IoT device, and a network device, such as a router or gateway device. In examples herein, a common key for encrypting data transferred between the user device and the network device is determined based on first physiological data captured by a first sensor of the user device and second physiological data captured by a second sensor of the network device. The first and second physiological data each represent the same physiological characteristic of the user. For example, the first and second physiological data may each represent an electrocardiogram (ECG) of the user. The user device and the network device each independently generate a key based on the first and second physiological data, respectively. However, as the first and second physiological data represent the same physiological characteristic of the user, the keys generated by the user device and the network device are also the same as each other, despite being generated independently. The user device can therefore use the key generated based on the first physiological data to decrypt data encrypted by the network device using the key generated based on the second physiological data, and vice versa. Each of the independently generated keys may be considered to correspond to a common key.

This approach obviates the need for a key exchange mechanism. Instead, the user device can use a first key generated locally based on the first physiological data to encrypt data for transmission to the network device and to decrypt data received from the network device. Similarly, the network device can use a second key generated locally based on the second physiological data to encrypt data for transmission to the user device and to decrypt data received from the user device. This simplifies the mutual authentication of the user device and the network device, and improves security.

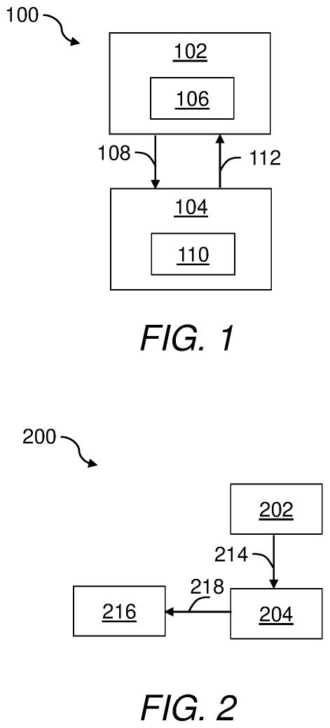

FIG. 1 is a schematic diagram of an example system 100 for establishing a common key to facilitate secure communication between a user device 102 and a network device 104. A user device is for example a device which is capable of obtaining and/or communicating data related to a user or a user environment. A user device may be a device to be included in the IoT, which may be referred to as an IoT device. The user device 102 of FIG. 1 includes a first sensor 106 which is configured to capture first physiological data representative of a physiological characteristic of a user. By virtue of the first sensor 106, the user device 102 is arranged to obtain information about the user's body, such as at least one vital signal of the user. In FIG. 1, the first sensor 106 includes an electrocardiograph device configured to obtain an electrocardiogram (ECG) of the user. An ECG represents a graph of voltage against time of the electrical activity of the heart of the user. The user device 102 in FIG. 1 is a wearable device, to enable the user device 102 to more accurately and straightforwardly obtain the first physiological data.

In FIG. 1, data captured by the user device 102 (e.g. by the first sensor 106 or another sensor of the user device 102) is encrypted based on the first physiological data, to generate encrypted data. The encrypted data may represent the same physiological characteristic as that represented by the first physiological data or a different physiological characteristic, and may be obtained during the same time period or a different time period as that in which the first physiological data is obtained. For example, the encrypted data may be the first physiological data itself.

Encrypting the data captured by the user device 102 (which may be referred to herein as user data) based on the first physiological data is secure, as physiological characteristics tend to be unique to a particular user. In FIG. 1, the first physiological data represents an ECG of the user. In this case, the physiological characteristic of the user that is detected by the first sensor is time-varying, as the electrical activity of the heart typically changes over time, as the heart beats. This further improves security by making it more difficult for a malicious party to attempt to determine the value of the physiological characteristic.

In the example of FIG. 1, encryption of the user data involves encrypting the user data using a first key with a value dependent on the first physiological data. For example, where the physiological characteristic is the ECG of the user, the first sensor 106 may sample the ECG (e.g. at a predefined sampling rate such as 125 Hertz) of the user, and then extract features from the sampled ECG. For example, a wavelet transform, such as the discrete wavelet transform (DWT), may be applied to the sampled ECG to extract the features. The features can then be combined (e.g. by concatenation) to form a feature vector. A suitable representation of the user data (in this case, the user's ECG), such as a numerical representation, can be obtained from the features, e.g. by quantizing the feature vector. This representation of the physiological characteristic may then be processed to generate the first key. A similar approach may be used to obtain a key from other physiological characteristics than an ECG.

The user device 102 sends the encrypted data 108 to the network device 104. A network device is a device that provides an entry point to a network or that filters and/or routes network traffic, such as a router, gateway device, switch, hub, access point or an edge device (which may be or comprise a router or routing switch). In FIG. 1, the network device is a gateway device, but this is merely an example. In FIG. 1, the network device 104 provides a local network, to which the user device 102 is connected. In other words, the system 100 of FIG. 1 includes a network comprising the user device 102 and the network device 104. The network device 104 can also be connected to a wider network, for example the Internet, in order to communicate with one or more remote servers. Although only a single network device 104 is shown in FIG. 1, it is to be appreciated that a local network could employ multiple access points and/or signal boosters to perform this function.

The network device 104 of FIG. 1 includes a second sensor 110 configured to capture second physiological data representative of the physiological characteristic of the user (i.e. the same physiological characteristic as that measured by the first sensor of the user device 102). The first and second sensors 110, 106 may be the same as each other, but form part of the user device 102 and the network device 104, or they may differ from each other but nevertheless detect the same physiological characteristic. In FIG. 1, the second sensor 110 of the network device 104 includes an electrocardiograph device configured to obtain an ECG of the user.

The network device 104 uses the second sensor 110 to independently sense the same physiological characteristic as that used by the user device 102 in generating the first key. Whereas the user device 102 in this case is a wearable device, the network device 104 in FIG. 1 is not wearable, although this is merely an example. The sensing of the physiological characteristic by the second sensor 110 of the network device 104 in this case may be initiated by the user moving into sufficient proximity of the network device 104 that the second sensor 110 can sense the physiological characteristic. This may involve the user placing the second sensor 110 into contact with their skin, although contact need not occur in some cases (e.g. depending on the physiological characteristic being detected).

The second physiological data and the encrypted data are then used to determine a common key for encrypting further data transferred between the user device 102 and the network device 104. The determination of the common key generally involves the user device 102 and the network device 104 reaching an agreement on the value of a key for encrypting and/or decrypting data sent to or from the user device 102 and the network device 104.

For example, at the network device 104, the common key may be considered to be determined when the network device 104 has determined a suitable key for decrypting the encrypted data 108 received from the user device 102. In the example of FIG. 1, this involves the network device 104 generating a second key with a value dependent on the second physiological data (e.g. in the same manner as the first key is generated by the user device 102). If the network device 104 is able to decrypt the encrypted data 108 using the second key (which will be the case if the first key and the second key match each other), then this is considered to correspond to determination of a common key. In this case, the first key and the second key each correspond to the common key. In other words, the user device 102 and the network device 104 have each independently generated a pairwise key for communication therebetween, without having to transfer the pairwise key to each other. This is more secure and efficient than other approaches that involve a key exchange mechanism. In addition, it obviates the need for a public key infrastructure, which is used in other approaches, such as Transport Layer Security (TLS), for managing public-key encryption that is reliant on digital certificates.

In this case, the first and the second key match each other where the first and second physiological data represent the same physiological characteristic captured over the same time period, e.g. where a first ECG captured by the first sensor 106 is the same as a second ECG captured by the second sensor 110. To facilitate the capturing of matching first and second physiological data in cases where the physiological characteristic is time-varying, in FIG. 1, the first physiological data is captured synchronously with the capturing of the second physiological data. For example, the first and second sensors 106, 110 may be synchronized prior to capturing the first and second physiological data, e.g. during a network setup phase in which the user device is first connected to the network of the network device. In this example, the first and second sensors 106, 110 remain synchronized, to allow the first and second physiological data to be captured synchronously. In this case, a time period within which the physiological characteristic is sensed by the first sensor 106 at least partly overlaps a time period within which the physiological characteristic is sensed by the second sensor 110. The first and second physiological data for example represent the physiological characteristic during the overlapping time period in which the physiological characteristic is detected by both the first and second sensor 106, 110. By generating the first key and the second key based on a physiological characteristic with a value that varies over time (and typically in a manner that is difficult to predict accurately), the first and second keys (and hence the common key) are difficult for a malicious party to guess.

The first and second sensor 106, 110 in FIG. 1 are each configured to detect the physiological characteristic as measured at the same location on the user's body, so that the first and second physiological data match each other. This is because some physiological characteristics may differ depend on where a sensor to detect the physiological characteristic is located on the body. For example, a graph of the user's pulse over time will differ depending on if the pulse is measured e.g. using a pulse oximeter placed on the user's right hand fingertip or a pulse oximeter placed on the user's left hand fingertip, due to the time taken for blood to flow around the body as it is pumped by the heart. In other cases, though, the first and second sensors 106, 110 need not be placed on the same body part as each other. In such cases, the first and/or second physiological data can be processed to reconcile any differences in the physiological characteristic that may be introduced due to a difference in a positioning of the first and/or second sensor on the user's body. After the network device 104 determines that the second key can decrypt the encrypted data 108 received from the user device 102, and hence that the second key corresponds to the common key, the network device 104 generates a response for sending to the user device 102. The response indicates that the encrypted data has been decrypted by the network device 104, and may be in any suitable format. The network device 104 encrypts the response using the second key, to generate an encrypted response. The network device 104 sends the encrypted response 112 to the user device 102. The user device 102 then attempts to decrypt the encrypted response 112 using the first key. In this case, as the first key and the second key each correspond to the common key, the user device 102 successfully decrypts the encrypted response using the first key. In this way, it is determined that the first key and the second key each correspond to the common key. The user device 102 can therefore use the first key to encrypt further data for sending to the network device 104 and to decrypt encrypted data received from the network device 104 (which has been encrypted using the second key).

It is to be appreciated that there may be additional communication between the user device 102 and the network device 104 than shown in FIG. 1 in determining the common key; FIG. 1 is simplified for ease of illustration.

The method performed by the system 100 of FIG. 1 to determine a common key may be performed repeatedly. In this way, a different common key can be established for each of a plurality of different time periods, respectively. In other words, for each performance of the method, a different common key is established for encrypting data transferred between the user device 102 and the network device 104. The common keys in this case have different values depending on when they are established due to the time-varying nature of the physiological characteristic on which they are based. Each of the common keys is hence unique in this example. This further improves security, as even if a malicious party is able to gain access to the common key at a particular time, they will be unable to access further data once the common key is refreshed (i.e. once a new common key is generated at a later time). Refreshment of the common key may be performed at predetermined time intervals or may be performed irregularly, e.g. after a certain amount of data is captured by the user device 102, which may vary depending on activity of the user.

Once the common key is established, it can be used to secure communication between the user device 102 and the network device 104. An example of such communication is shown in FIG. 2, which shows schematically a system 200 for storing data in a distributed ledger. Features of FIG. 2 that are similar to corresponding features of FIG. 1 are labelled with the same reference numerals but incremented by 100; corresponding descriptions are to be taken to apply.

In FIG. 2, a user device 202 and a network device 204 have already established a common key, e.g. as described with reference to FIG. 1, based on first physiological data captured by a first sensor of the user device 202 and second physiological data captured by a second sensor of the network device 204. The first and second physiological data are each representative of a physiological characteristic of a user, e.g. an ECG. Although not shown in FIG. 2, for ease of illustration, it is to be appreciated that the user device 202 includes a first sensor, similar to the first sensor 106 of FIG. 1, and the network device 204 includes a second sensor, similar to the second sensor 110 of FIG. 1. The user device 202 then captures further physiological data representative of the physiological characteristic. The user device 202 encrypts the further physiological data using the common key (which e.g. corresponds to a first key generated by the user device 202 based on the first physiological data), to generate user data. The user device 202 sends the user data 214 to the network device 204, which is in communication with a node 216 of a distributed ledger network (DLN) such as a blockchain network, e.g. via a further network such as the Internet.

The node 216 is configured to store a distributed ledger of the DLN, and may be any suitable computing device for storing a distributed ledger. A ledger in examples herein is a digital ledger including a series of blocks, which generally grows over time as additional data is added to the ledger. Each block is linked to a previous block in the series using cryptographic hashing. Typically, each block includes a timestamp, transaction data (e.g. representing a data record), and a hash of the previous block. A hash function for performing cryptographic hashing may be considered to be a one-way function that maps a given input (such as a data record) to an output, typically of a fixed size. Such a function is one-way in that the input cannot be recovered from the output, even if the function itself is known. Chaining successive blocks cryptographically allows changes to an individual block to be readily detected by detecting a difference between the hash of the block and the hash of the block as stored in the subsequent block of the chain. Hence, to successively alter the data of a given block without detection, all subsequent blocks must also be altered, which is generally difficult to achieve undetected. Such a ledger is therefore resistant to tampering.

To further increase the resistance to tampering, the ledger is stored in a decentralized manner, i.e. it is a distributed ledger. The ledger is synchronized across a plurality of nodes of the DLN, including the node 216 of FIG. 2, so that each of the nodes stores a separate copy of the ledger. This removes a centralized point of failure from the DLN, increasing the immutability of the data. For example, to alter the data of a given block, a majority of nodes of the DLN must consent to the alteration, and with the alternation of all subsequent blocks of the ledger. The DLN, and hence the distributed ledger stored within the DLN, is therefore secure by design, as consensus will typically not be achieved for attempts to maliciously alter the distributed ledger.

The network device 204 sends further user data 218 derived from the user data to the node 216, for storage of the further user data in the distributed ledger. The further user data may be the same as the user data, which is encrypted using the common key. However, in this case, for such data to be decrypted by a further device, such as a client device, the common key would have to be shared with the further device. This may reduce the security of the system, as the client device would then also be able to decrypt other data sent between the user device 202 and the network device 204 that is encrypted using that particular common key. Hence, in other cases, the further user data may be derived from the user data, but encrypted using a further key, different from the common key. This is the case in FIG. 2, in which the network device 204 decrypts the user data using the common key to generate decrypted user data. The network device 204 then encrypts the decrypted user data using the further key to generate the further user data. The further key can then be shared with a further device if it is desired to give the further device the capability of decrypting the further user data. With this approach, a plurality of sets of user data encrypted using the same common key may be decrypted by the network device 204 and then encrypted using different further keys, respectively. This further improves the security of the user data, as access to each set of user data can be controlled individually, by controlling which further device(s) each further key is shared with.

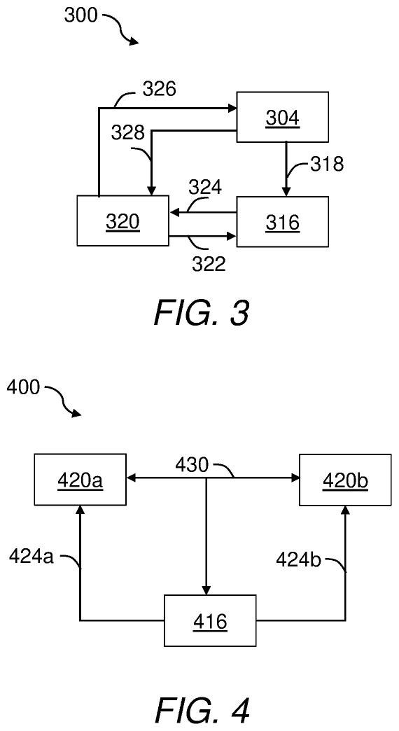

FIG. 3 shows schematically an example system 300 for sending user data to a client device 320. Features of FIG. 3 that are similar to corresponding features of FIG. 2 are labelled with the same reference numerals but incremented by 100; corresponding descriptions are to be taken to apply. In FIG. 3, a network device 304 sends user data 318 received from a user device to a node 316 of a DLN. The user data in the context of FIG. 3 may be further user data derived from user data, e.g. as described with reference to FIG. 2. In such cases, the user data obtained by the network device 304 from the user device may be encrypted using a common key, which may be established as described with reference to FIG. 1.

In FIG. 3, rather than obtaining the user data from the network device 304, the client device 320 instead obtains the user data from the distributed ledger, from the node 316 of the DLN. This is more secure, as data stored in the distributed ledger is typically more resistant to tampering than data stored locally on a single device or system. The client device 320 sends a request 322 to the node 316 for the user data. The user data may be identified within the distributed ledger in various ways. For example, the request 322 may include suitable identifying information to allow the particular user device that captured the user data to be identified. The distributed ledger may then be searched by the node 316 to locate block(s) that include data captured by that particular user device. The node 316 then sends the user data 324 to the client device 320.

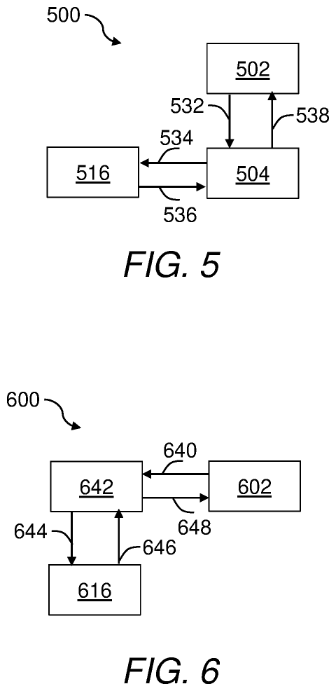

In this example, the user data 324 obtained by the client device 320 from the node 316 is encrypted. To decrypt the user data, the client device 320 sends a request 326 to the network device 304 for a suitable key. Communication between the client device 320 and the network device 304 (including the request 326) may be secured using a suitable cryptographic protocol, e.g. an existing protocol based on asymmetric encryption, and may be performed via a network such as the Internet. The network device 304 sends the key 328 to the client device 320. In this way, the network device 304 can control which client devices are provided with the key 328 and are able to decrypt the user data. In this way, access to the user data can be restricted to particular client devices that satisfy certain requirements, as explained further with reference to FIG. 5. The key 328 is for example a secret key, which is to be kept secret by the network device 304 and the client device 320 to reduce the risk of unauthorized access to the user data by other parties. The client device 320 can then decrypt the user data using the key 328 received from the network device 304. It is to be appreciated that that the key 328 may be obtained by the client device 320 before or after the user data 324 is obtained.

Using the approach of FIG. 3, the user data can be transferred in a secure manner to further devices, such as the client device 320. This approach can be used, for example, to securely transfer user data in a healthcare setting, e.g. representing at least one physiological characteristic of a user. The user data can be sent to a client device associated with a healthcare organization such as a hospital or physician, via the DLN. The user can also or instead use this approach to access their own user data from the DLN, using a client device associated with the user, such as a smartphone or laptop of the user.

FIG. 4 shows schematically an example system 400 for obtaining data from a distributed ledger. The system 400 of FIG. 4 can be used where data is to be shared with a third party other than the user, such as a healthcare provider. In FIG. 4, a first client device 420a, which in this example is associated with a healthcare provider, requests a first copy of user data 424a from a node 416 of a DLN. The user data from which the first copy of user data 424a is obtained may have been stored in a distributed ledger of the DLN as described with reference to FIGS. 1 and 2. The first client device 420a receives the first copy of the user data 424a. The first copy of the user data 424a may have been encrypted prior to storage in the distributed ledger, and may be decrypted using a suitable key obtained by the first client device 420a as described with reference to FIGS. 2 and 3.

In this example, a user of a second client device 420b also wishes to obtain the user data. In this case, the second client device 420b obtains a second copy of the user data 424b from the node 416. As for the first copy of the user data 424a, the second copy of the user data 424b may also be encrypted, and may be decrypted using a suitable key obtained by the second client device 420b as described with reference to FIGS. 2 and 3. The first and/or second client devices 420a, 420b obtaining the user data from the distributed ledger is for example more secure than the first client device 420a obtaining the user data from the second client device 420b or vice versa. This is because user data stored on the first or second client devices 420a, 420b may be more susceptible to tampering than the user data stored in the distributed ledger.

To further enhance security, in this example, the first client device 420a executes a smart contract 430 with the second client device 420b. The smart contract 430 represents an agreement for sharing of the user data with the first client device 420a. This provides the user with control over how the first client device 420a (and in this case, the healthcare provider associated with the first client device 420a) is permitted to use the user data. For example, the smart contract 430 may be used to enforce certain restrictions on the use of the user data, e.g. to prevent the healthcare provider from using the user data for marketing purposes. A smart contract is for example a self-executing contract with the terms of the agreement for the sharing of the user data being encoded in program code of the smart contract. Such a smart contract can therefore be used to enforce the agreement, e.g. to prevent use of the user data that the user does not consent to.

The smart contract 430 is for example executed before the user data is provided to the first client device 420a, or before the first client device 420a is provided with a suitable key to decrypt the user data.

To further enhance security, authorization of a user device, a client device and/or a network device may be verified before the methods herein (or parts thereof) are performed. This will now be explained with reference to FIGS. 5 to 7.

FIG. 5 is a schematic diagram of an example system 500 for authorizing a user device 502. A network device 504 receives user authorization data 532 from the user device 502. The user authorization data 532 is for use in authorizing the user device 502 and/or the user, and may represent at least one characteristic of the user device 502 and/or the user. The user device 502 for example sends the user authorization data 532 in response to the user device 502 being connected to the network device 504 via a suitable connection, which may be wired or wireless.

In the example of FIG. 5, at least a portion of the user authorization data is indicative of a certificate associated with the user device 502. The certificate may indicate that a configuration of the user device 502 complies with a technical standard and/or legal requirement. A technical standard may be a standard set by a standard-setting body. Satisfying a particular technical standard for example indicates that the configuration of the user device 502 meets a given security standard. Hence, such a user device 502 can connect to the network device 504 and send data to the network device 504 without unduly exposing the network to security risks. A legal requirement may be set by any suitable legal or other regulatory body, which may be a national legal body or an international legal body. Satisfying a particular legal requirement for example indicates that the configuration of the user device 502 complies with a given legal rule or other regulation, such as the General Data Protection Regulation (GDPR). For example, a user device 502 may have a particular configuration such that data is protected and privacy of the data is maintained in compliance with the GDPR. It will be appreciated that the user authorization data may represent a plurality of features of the user device 502 and/or the user, such as a certificate that the user device 502 complies with a technical standard and a further certificate that the user device 502 complies with a legal requirement. In other examples, the user authorization data may instead or in addition represent at least one feature of the user, such as an identity of the user, e.g. as represented by identity documents associated with the user such as a passport, driving license or a smart card issued to the user. In this way, the identity of the user can be verified instead of in addition to the configuration of the user device 502, e.g. to verify that the user is authorized to access the network and/or to send user data to a distributed ledger via the network device 504 as described with reference to FIG. 2.

A certificate associated with the user device 502 is for example previously issued by a verification system configured to verify compliance with at least one requirement (such as a technical standard or a legal requirement). This is explained further with reference to FIG. 6. The portion of the user authorization data may represent the certificate or may be otherwise derived from the certificate. For example, the user authorization data may represent at least one flag or code (which may e.g. be alphabetical, numerical or alphanumerical) indicating at least one feature of the user device 502 and/or the user. For example, the user authorization data may include a flag indicating that the user device 502 complies with the GDPR.

The network device 504 sends a user authorization data request 534 to a node 516 of a DLN. The user authorization data request 534 may be in any suitable form. In some cases, the user authorization data request 534 includes a request, based on an identifier indicative of a block of the distributed ledger in which a version of the user authorization data is stored, for block data representative of at least part of the block. This facilitates retrieval of the version of the user authorization data from the distributed ledger. In such cases, the identifier may be received at the network device 504 from the user device 502, either as part of the user authorization data 532 or as a separate message or other communication. The identifier may be a block identifier (sometimes referred to as a block ID) representing the identity of the block of the distributed ledger in which the version of the user authorization data is stored. In other cases, though, the identifier may indirectly indicate the block of the distributed ledger in which the version of the user authorization data is stored. For example, the identifier may represent a transaction identifier (sometimes referred to as a transaction ID), allowing a block including a transaction including the version of the user authorization data to be identified.

The distributed ledger may be a public distributed ledger, e.g. stored in a public DLN. This facilitates the use of existing public distributed ledgers, which simplifies the use of the methods herein. Methods herein can be implemented securely despite the use of a public DLN. For example, the version of the user authorization data may be encrypted or otherwise cryptographically secured prior to storage in the distributed ledger. As an example, a cryptographic hash of a certificate associated with the user device 502 may be stored in the distributed ledger rather than the certificate itself.

After receiving the user authorization data request 532, the node 516 of the DLN sends a response 536 to the network device 504. authorization of the user device 502 is then determined based at least in part on the response 536 from the node 516. The authorization of the user device 502 is performed by the network device 504 in the example of FIG. 5, but may be performed by a further computing device in other examples. For example, the network device 504 may send the response 536 to the further computing device, such as a remote server system, and receive an indication from the further computing device of whether the user device 502 is authorized.

In some cases, the response 536 indicates that the distributed ledger lacks the version of the user authorization data. This may be the case where the user device 502 is unauthorized and e.g. does not satisfy certain requirements to be granted authorization. The response 536 may be a negative or null response, indicating that the version of the user authorization data has not been located. Alternatively, the response 536 may be a lack of communication from the node 516 for a given period of time (which may be considered to correspond to a timeout). In these cases, it is determined that the user device 502 is unauthorized, as there has been a failure to provide sufficient evidence within the given period of time that the user device 502 is authorized. The network device 504 in these cases therefore prevents the user device 502 from connecting to the network device 504 and does not send user data received from the user device 502 to the node 516 of the DLN. In FIG. 5, though, the response 536 includes the version of the user authorization data.

The network device 504 validates the user authorization data 532 received from the user device 502 against the version of the user authorization data received from the node 516 of the DLN. The network device 504 then sends user data received from the user device 502 to the node 516 of the DLN, e.g. in the form of further user data generated by decrypting the user data using the common key and encrypting the decrypted user data using a further key. In this case, the network device 504 also grants the user device 502 access to the network associated with the network device 504.

Validating the user authorization data may include verifying a digital signature of the version of the user authorization data. For example, the version of the user authorization data may be digitally signed by a verification system configured to verify at least one characteristic of the user device 502 and/or the user. The verification system is for example associated with a regulatory authority, which is trusted to issue user authorization data (e.g. representative of a certificate) indicating that a given user device and/or user complies with a particular requirement. This allows the issuing of the user authorization data by the verification system to be verified by third parties, such as the network device 504. For example, authorizing the user device 502 may be based at least in part on verifying that the digital signature of the user authorization data is associated with the verification system. In one such example, the verification system has issued a certificate associated with the user device 502. The certificate is digitally signed by the verification system to generate a digital signature representing an encrypted version of the certificate, encrypted using a private key associated with the verification system. In these cases, the network device 504 can obtain a copy of a public key associated with the verification system (which forms an asymmetric key pair with the private key). The user authorization data represents both the certificate and the encrypted version of the certificate. The network device 504 can then decrypt the encrypted version of the certificate with the public key associated with the verification system. If the decrypted version of the certificate matches the original certificate, the digital signature of the user authorization data is verified as being associated with the verification system. In this way, the authenticity of the user authorization data can be verified. It is to be appreciated that a similar approach may be used to verify the digital signature of the user authorization data in other examples in which the user authorization data represents a different feature of the user device 502 and/or user than a certificate associated with the user device 502, e.g. a hash of a certificate (discussed further below) or a flag or code. The network device 502 may also verify a digital signature of the user authorization data in a similar way to verification of the digital signature of the version of the user authorization data obtained from the node 516, but using a public key associated with the user device 504 rather than the verification system.

In FIG. 5, the network device 504 validates the user authorization data 532 against the version of the user authorization data obtained from the node 516. The user authorization data 532 provided by the user device 502 is generally easier for a malicious party to modify than the version of the user authorization data, which is stored securely in the distributed ledger. Hence, by validating the user authorization data 532 against the version of the user authorization data it can be determined that the user authorization data 532 is reliable, and that the user device 502 is authorized. The user device 502 in FIG. 5 is then permitted to store user data in the distributed ledger (via the network device 504) and is granted access to the network to send the user data to the node 516 of the DLN.

In examples such as that example of FIG. 5, determining whether the user device 502 is authorized may be considered to correspond to determining whether the user device 502 satisfies a network access requirement. A network access requirement for example represents a requirement that the user device 502 must satisfy or otherwise meet or exceed in order to be granted access to the network of the network device 504. In some cases, the network access requirement is a requirement that a configuration of the user device 502 complies with a predefined configuration. The predefined configuration may be a hardware and/or software configuration. For example, the user device 502 may be considered to comply with the network access requirement where the user device 502 includes particular anti-virus, anti-malware or firewall software, or where the user device 502 has received a particular software update (sometimes referred to as a patch) to reduce a vulnerability of the user device 502 to an attack.

In a further example, the user device 502 may be considered to comply with the network access requirement if the user device 502 is an authenticated participant of the DLN.

If the comparison between the user authorization data and the version of the user authorization data indicates that they differ, though, it is determined that the user device 502 is to be denied access to the network, and user data received by the network device 504 from the user device 502 is not to be stored in the DLN. This is because such a difference may indicate that the user authorization data 532 has been tampered with, and that a security of the user device 502 has hence been compromised.

In examples, the user authorization data 532 and the version of the user authorization data have each been secured cryptographically, e.g. via cryptographic hashing. This further enhances security, as the user authorization data 532 and the version of the user authorization data can be transferred between the various components of the example system 500 without risking exposure of the user authorization data 532 and the version of the user authorization data themselves, which may be considered sensitive information.

In FIG. 5, it is determined that the user device 502 is authorized. In this case, the network device 504 performs this authorization and communicates 538 with the user device 502 to grant the user device 502 access to the network. The user device 502 can then send user data for storage in the DLN to the network device 504, encrypted using the common key.

Authorization of the user device 502 as described with reference to FIG. 5 may be performed before the user data is sent to the node 516 of the DLN. The authorization of the user device 502 is for example performed after the common key for communication between the user device 502 and the network device 504 is established, e.g. as described with reference to FIG. 1, so that the communication between the user device 502 and the network device 504 during authorization of the user device 502 is secure. For example, the common key can be used to encrypt and decrypt communications sent between the user device 502 and the network device 504 during authorization of the user device 502.

A similar authorization procedure as that described with reference to FIG. 5 may be performed to authorize a client device, such as the client devices 320, 420a, 420b described with reference to FIGS. 3 and 4. In such cases, the network device receives client authorization data from a client device for use in authorizing the client device. The client authorization data may be similar to the user authorization data, and may represent at least one characteristic of the client device, such as a certificate associated with the client device, indicating compliance of the client device with a technical standard and/or a legal requirement. The network device then validates the client authorization data against a version of the client authorization data stored in the distributed ledger, e.g. by obtaining the version of the client authorization data in a similar way to obtaining the user authorization data. In response to validating the client authorization data, the network device than sends a suitable key to the client device for decrypting user data obtained by the client device from the distributed ledger. The key may for example be a further key for decrypting further user data obtained from the distributed ledger. Security is further enhanced with this approach, as it allows the sharing of keys for decryption of user data to be controlled, e.g. so that keys are only shared with client devices that satisfy particular requirements.

FIG. 6 is schematic diagram of an example system 600 for storing user authorization data for authorizing a user device 602. Methods performed using the example system 600 of FIG. 6 for storing the user authorization data in a distributed ledger may be performed before methods performed using the example system 500 of FIG. 5 for authorizing a user device. In other words, at least one characteristic of the user device 606 may first be verified, before it is determined whether the user device 606 is authorized.

The user device 602 sends characteristic data 640 representative of at least one characteristic of at least one of the user device 602 or the user to a verification system 642 configured to verify the at least one characteristic. For example, the verification system 642 may be configured to verify that the at least one characteristic satisfies a particular requirement, e.g. for the user device 602 to comply with a technical standard or a legal requirement. The at least one characteristic of the user device 602 for example includes at least one feature of a configuration of the user device 602, such as a software and/or hardware configuration of the user device 602. The at least one characteristic may indicate functionality of the user device 602, e.g. from which it can be determined whether the user device 602 has appropriate functionality to process and/or store data securely, such as in a manner compliant with a particular requirement. In general, the at least one characteristic of the user device 602 and/or user may be or include any suitable characteristic for use in assessing whether the user device 602 and/or user comply with a particular requirement that the verification system 642 is configured to verify. The characteristic data 640 sent to the verification system 642 may hence depend on which requirement the user device 602 is to be assessed for compliance with.

The verification system 642 in FIG. 6 is a system associated with a trusted authority, which is for example an entity that is generally regarded as being trustworthy, and which can be relied upon to accurately verify compliance with a particular requirement. In some cases, the verification system 642 is associated with a regulatory authority, which may (although need not) be the same regulatory authority that issues or maintains a particular standard or regulation that must be complied with for the user device 602 to be considered authorized.

In FIG. 6, the verification system 642 receives the characteristic data 640 from the user device 602. However, in other examples, the verification system 642 may instead retrieve the characteristic data from a different device or system. For example, the user device 602 may send an identifier to the verification system 642, along with a request for verification of compliance of the user device 602 with a particular requirement. The verification system 642 may then obtain the characteristic data corresponding to the user device 602 (e.g. identified using the identifier received from the user device 602) from a different device or system, such as a server system associated with a manufacturer of the user device 602.

In FIG. 6, the verification system 642 is configured to process the characteristic data to verify the at least one characteristic. This may involve, for example, determining whether the user device 602 includes a particular software and/or hardware configuration, as discussed further above with reference to FIG. 5. In FIG. 6, the verification system 642 successfully verifies the at least one characteristic. The verification system 642 generates user authorization data for use in authorizing at least one of the user device or the user. The user authorization data may be the same as or similar to the user authorization data described with reference to FIG. 5, and may hence represent or be derived from a certificate, and may be digitally signed by the verification system 642. Digital signing of the certificate allows third party entities (such as a network device) to verify that the user authorization data was generated by the verification system 642, e.g. as explained with reference to FIG. 5.

A version of the user authorization data 644 is then sent from the verification system 642 to a node 616 of a DLN, for storing in a distributed ledger of the DLN. In FIG. 6, the node 616 sends an identifier 646 to the verification system 642, allowing the block of the distributed ledger in which the user authorization data is stored to be identified. The identifier 646 may for example be a block ID or a transaction ID for the distributed ledger. In this way, the user authorization data is stored in the distributed ledger.

Storage of the user authorization data in the distributed ledger by the verification system 642 may be considered to correspond to registering of the user authorization data in the distributed ledger. The distributed ledger stores the user authorization data immutably, meaning that subsequent changes in the user authorization data stored in the storage of the user device 602 can be detected. In this way, a malicious third party cannot merely alter the user authorization data of the user device 602 to gain access to the network. With this approach, the trust of the verification system 642 is leveraged to generate (and store in the distributed ledger) user authorization data which is itself trustworthy. A network device can rely on the integrity of the version of user authorization data obtained from the distributed ledger because it was initially generated by a trustworthy entity (the verification system 642) and because it is resistant to modification, by virtue of its storage in the distributed ledger. This obviates the need for the user device to send the user authorization data to a network device each time the user device is to be connected to a new network. Instead, the network device can retrieve the user authorization data from the distributed ledger. The user authorization data can indicate compliance of the user device with particular requirements without including specific information about the user device. Hence, using the user authorization data to determine whether the user device is to be granted access to a network may reduce the risk of sensitive information about the user device (e.g. as represented by the characteristic data) from being obtained by a malicious party. Moreover, it can be more efficient to obtain the user authorization data from the distributed ledger rather than from the verification system 642 itself (which may not have the capacity to deal with a high volume of requests). This is especially so, as the distributed ledger may be stored at a node that is physically closer to the network device, e.g. which a node which also forms part of the network for which a network access determination for the user device is to be made.

In FIG. 6, the verification system 642 also sends a response 648 to the user device 602, which in this case includes the user authorization data and the identifier 646. The user authorization data may be hashed or otherwise cryptographically secured before it is sent to the user device 602 and/or the node 616. The user authorization data is then stored in storage of the user device 602. The user authorization data may be stored in a digital wallet associated with the user device 602, which is for example secure storage of or accessible to the user device 602 for storing private information such as financial records. The user device 602 can then provide the user authorization data to other devices or systems, such as a network device, for use in proving that the user device 602 is authorized. This may involve comparing the user authorization data obtained from the user device 602 with a version of the user authorization data obtained from the distributed ledger, as described with reference to FIG. 5.

Client authorization data for use in authorizing a client device and/or network device for use in authorizing a network device may be generated and stored in a similar manner to the generation and storage of the user authorization data described with reference to FIG. 6. For example, a client device may send client characteristic data representative of at least one characteristic of the client device to a verification system configured to verify the at least one characteristic. At least a portion of the client authorization data may be indicative of a certificate associated with the client device, e.g. indicating that a configuration of the client device complies with a technical standard and/or legal requirement. The client device may then receive client authorization data from the verification system, and may then send the client authorization data to a further device, such as the network device, to allow the further device to authorize the client device. In a similar way, a network device may send network device characteristic data representative of at least one characteristic of the network device to a verification system configured to verify the at least one characteristic. At least a portion of the network device authorization data may be indicative of a certificate associated with the network device, e.g. indicating that a configuration of the network device complies with a technical standard and/or legal requirement. The network device may then receive network device authorization data from the verification system, and may then send the network device authorization data to a further device, such as the client device, to allow the further device to authorize the network device. The same verification system may be used for verification of the user device, client device and/or network device, or a different verification system may be used for verification of at least one of the user device, client device and/or network device.

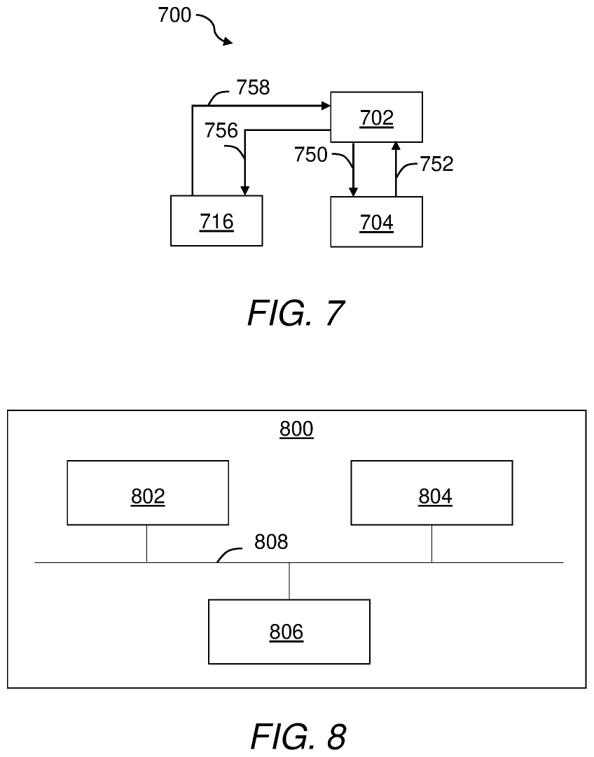

An example system 700 for authorizing a network device 704 is shown schematically in FIG. 7. In FIG. 7, before a user device 702 sends user data captured by a first sensor of the user device 702 to the network device 704, the user device 702 sends a request 750 to the network device 704 for network device authorization data. The network device 704 sends the network device authorization data 752 to the user device 702. The user device 702 also sends a request 754 to a node 716 of a DLN for a version of the network device authorization data stored in a distributed ledger of the DLN. The user device 702 receives the version of the network device authorization data 758 from the node 716. The user device 702 then validates the network device authorization data 752 against the version of the network device authorization data 758 to determine whether the network device 704 is authorized to receive user data captured by the user device 702. This validation is for example performed similarly to the validation of the user authorization data described with reference to FIG. 5.

If the user device 702 determines that the network device 704 is authorized, e.g. if the network device authorization data matches the version of the network device authorization data, and the version of the network device authorization data indicates that a configuration of the network device 704 satisfies a particular requirement, e.g. compliance with a technical standard and/or legal requirement, the user device 702 sends further user data (encrypted using the common key) to the network device 704. Otherwise, the user device 702 ceases sending user data to the network device 704, as this indicates that the network device 704 may have been compromised or that the network device 704 is not sufficiently secure to handle the storage of user data captured by the user device 702.

FIG. 8 is a schematic diagram of internal components of a data processing system 800 that may be used in any of the methods described herein. The data processing system 800 may include additional components not shown in FIG. 8; only those most relevant to the present disclosure are shown. The data processing system 800 may be or form part of a network device (e.g. a router or gateway device), a verification system, a user device, a node of a DLN, a client device or a further computing device. The data processing system 800 in FIG. 8 is implemented as a single computer device but in other cases a data processing system otherwise the same as or similar to that of FIG. 8 may be implemented as a distributed system.

The data processing system 800 includes storage 802 which may be or include volatile or non-volatile memory, read-only memory (ROM), or random access memory (RAM). The storage 802 may additionally or alternatively include a storage device, which may be removable from or integrated within the data processing system 800. For example, the storage 802 may include a hard disk drive (which may be an external hard disk drive such as a solid state disk) or a flash drive. The storage 802 is arranged to store data, temporarily or indefinitely. The storage 802 may be referred to as memory, which is to be understood to refer to a single memory or multiple memories operably connected to one another.

The storage 802 may be or include a non-transitory computer-readable medium. A non-transitory computer-readable storage medium includes, but is not limited to, volatile memory, non-volatile memory, magnetic and optical storage devices such as disk drives, magnetic tape, compact discs (CDs), digital versatile discs (DVDs), or other media that are capable of storing code and/or data.

The data processing system 800 also includes at least one processor 804 which is configured to implement at least part of any of the methods described herein. The at least one processor 804 may be or comprise processor circuitry. The at least one processor 804 is arranged to execute program instructions and process data. The at least one processor 804 may include a plurality of processing units operably connected to one another, including but not limited to a central processing unit (CPU) and/or a graphics processing unit (GPU).

The data processing system 800 further includes a network interface 806 for connecting to at least one network. A data processing system otherwise similar to the data processing system 800 of FIG. 8 may additionally include at least one further interface for connecting to at least one further component. The components of the data processing system 800 are communicably coupled via a suitable bus 808.

Alternatives and Modifications A user device which may be used as any of the user devices in the examples above may be any device that comprises a suitable sensor for capturing the first physiological data. Such a user device may be wearable, but need not be. In some cases, a user device for use in the examples herein may include additional functionality than measurement of physiological properties of the user. For example, a user device may include at least one further sensor than a first sensor configured to obtain the first physiological data, e.g. to detect at least one further property of the user and/or an ambient environment.

In FIG. 1, the first and second sensors are arranged to obtain an ECG of the user.

However, this is not intended to be limiting, and in other cases the first and second sensors may each detect a different physiological characteristic of the user instead of or in addition to an ECG, which may be time-varying. An example of obtaining a first key with a value dependent on the first physiological data. It is to be appreciated that this is merely an example, and other approaches may be used in other cases.

A system similar to the system 200 of FIG. 2 may be used to secure communication sent from a user device to a network device, e.g. including data other than the further physiological data, such as data representative of a different physiological characteristic than the first physiological characteristic.

In the example of FIG. 5, the user device 502 sends user authorization data 532 to the network device 504, which the network device 504 uses to authorize the user device 502. In other examples, though, the user device 502 may instead send a request for access to the network and/or for access to the distributed ledger. Receipt of such a request may cause the network device 504 to transmit the request 534 to the node 516 for the version of the user authorization data, which the network device 504 may use to authorize the user device 502. For example, the network device 504 may determine that the user device 502 is authorized if the network device 504 is able to obtain the version of the user authorization data from the node 516.

Each feature disclosed herein, and (where appropriate) as part of the claims and drawings may be provided independently or in any appropriate combination.

Any reference numerals appearing in the claims are for illustration only and shall not limit the scope of the claims.

1. A method for facilitating secure communication between a user device and a network device, the method comprising:
receiving, at the network device, encrypted data from the user device, wherein the encrypted data is encrypted based on first physiological data captured by a first sensor of the user device, the first physiological data representative of a physiological characteristic of a user of the user device;
capturing, by a second sensor of the network device, second physiological data representative of the physiological characteristic of the user; and
determining, based on the encrypted data and the second physiological data, a common key for encrypting further data transferred between the user device and the network device.

2. The method according to claim 1, wherein the encrypted data is encrypted using a first key with a value dependent on the first physiological data, and determining the common key comprises:
the network device generating a second key with a value dependent on the second physiological data; and
the network device using the second key to decrypt the encrypted data, thereby determining that the first key and the second key each correspond to the common key.

3. The method according to claim 1, wherein the first physiological data is captured synchronously with the capturing of the second physiological data.

4. The method according to claim 1, wherein the physiological characteristic is a time-varying physiological characteristic, and wherein optionally the first physiological data and the second physiological data each represent an electrocardiogram (ECG) of the user.

5. The method according to claim 1, wherein the network device comprises a gateway device.

6. The method according to claim 1, wherein the method is performed repeatedly to determine, for each performance of the method, a different respective common key for encrypting data transferred between the user device and the network device during a different respective time period.

7. The method according to claim 1, further comprising:
the network device receiving user data from the user device, wherein the user data is encrypted using the common key; and
the network device sending further user data derived from the user data to a node of a distributed ledger network (DLN) configured to store a distributed ledger of the DLN, for storage of the further user data in the distributed ledger.

8. The method according to claim 7, further comprising:
the network device decrypting, using the common key, the user data to generate decrypted user data; and
the network device encrypting the decrypted user data using a further key, different from the common key, to generate the further user data.

9. The method according to claim 8, further comprising:
the network device receiving client authorization data from a client device for use in authorizing the client device;
the network device validating the client authorization data against a version of the client authorization data stored in the distributed ledger; and
the network device sending the further key to the client device.

10. The method according to claim 7, further comprising:
the network device receiving user authorization data from the user device for use in authorizing authorising at least one of: the user device or the user; and
the network device validating the user authorization data against a version of the user authorization data stored in the distributed ledger before sending the further user data to the node of the DLN.

11. The method according to claim 10, wherein at least a portion of the user authorization data is indicative of a certificate associated with the user device.

12. The method according to claim 11, wherein the certificate associated with the user device indicates that at least one of: a configuration of the user device complies with a technical standard, or a configuration of the user device complies with a legal requirement.

13. The method according to claim 10, wherein the network device is associated with a network, and the network device validates the user authorization data against the version of the authorization data stored in the distributed ledger before granting access to the network to the user device.

14. A method for facilitating secure communication between a user device and a network device, the method comprising:
capturing, at a first sensor of a user device, first physiological data representative of a physiological characteristic of a user of the user device;
encrypting, at the user device, the first physiological data based on the first physiological data, thereby generating encrypted data;
sending the first physiological data from the user device to a network device; and
determining, based on the encrypted data and second physiological data captured by a second sensor of the network device, a common key for encrypting further data transferred between the user device and the network device.

15. The method according to claim 14, wherein the encrypted data is encrypted using a first key with a value dependent on the first physiological data, and determining the common key comprises:
the user device receiving an encrypted response from the network device, the encrypted response indicative of decryption of the encrypted data by the network device using a second key with a value dependent on the second physiological data; and
the user device decrypting the encrypted response using the first key, thereby determining that the first key and the second key each correspond to the common key.

16. The method according to claim 14, further comprising:
the first sensor of the user device capturing further physiological data representative of the physiological characteristic of the user;
the user device encrypting the further physiological data using the common key, thereby generating user data; and
the user device sending the user data to the network device.

17. The method according to claim 16, further comprising, before the user device sends the user data to the network device:
the user device receiving network device authorization data from the network device for use in authorizing authorising the network device; and
the user device validating the network device authorization data against a version of the network device authorization data stored in a distributed ledger.

18. The method according to claim 17, wherein at least a portion of the network device authorization data is indicative of a certificate associated with the network device.

19. The method according to claim 14, further comprising:
the user device sending user characteristic data representative of at least one characteristic of at least one of the user device or the user to a verification system configured to verify the at least one characteristic; and
the user device receiving, from the verification system, user authorization data for use in authorizing the at least one of the user device or the user.

20. The method according to claim 19, further comprising the user device sending the user authorization data to the network device for use in authorizing the at least one of: the user device or the user.

21. A network comprising:
a network device; and
a user device comprising a first sensor configured to capture first physiological data representative of a physiological characteristic of a user of the user device, wherein the user device is configured to:
encrypt data captured by the first sensor, based on the first physiological data, to generate encrypted data; and
send the encrypted data to the network device,
wherein the network device comprises a second sensor configured to capture second physiological data representative of the physiological characteristic of the user, and the user device and the network device are configured to determine, based on the encrypted data and the second physiological data, a common key for encrypting further data transferred between the user device and the network device.

22. A method of operating a network comprising a user device and a network device, the method comprising:
capturing, using a first sensor of the user device, first physiological data representative of a physiological characteristic of a user of the user device;
encrypting data captured by the first sensor, based on the first physiological data, to generate encrypted data;
sending the encrypted data to the network device;
capturing, using a second sensor of the network device, second physiological data representative of the physiological characteristic of the user; and
determining, based on the encrypted data and the second physiological data, a common key for encrypting further data transferred between the user device and the network device.

23. A method for facilitating secure communication of user data captured by a user device to a client device, the method comprising:
the client device sending client characteristic data representative of at least one characteristic of the client device to a verification system configured to verify the at least one characteristic;
the client device receiving, from the verification system, client authorization data for use in authorizing the client device;
the client device sending the client authorization data to a network device;
the client device receiving a key from the network device;
the client device receiving, from a node of a distributed ledger network (DLN), user data captured by a user device; and
the client device decrypting the user data using the key.

24. The method according to claim 23, wherein the client device is a first client device and the method further comprises:
the first client device executing a smart contract with a second client device associated with a user of the user device, the smart contract representing an agreement for sharing of the user data with the first client device,
wherein the smart contract is stored in a distributed ledger of the DLN.

25. The method according to claim 23, wherein at least a portion of the client authorization data is indicative of a certificate associated with the client device.
